(19) United States
(12) Patent Application Publication
(10) Pub. No.: US 2012/0085046 A1
(43) Pub. Date: Apr. 12, 2012

(54) Support Bracket

(75) Inventor: Trevor Proctor, Brookvale (AU)

(73) Assignee: Ecobuild Solutions Limited, Cromer (AU)

(21) Appl. No.: 13/130,907

(22) PCT Filed: Nov. 24, 2009
(86) PCT No.: PCT/AU09/01526

§ 371 Date: Nov. 2, 2011

(30) Foreign Application Priority Data
Nov. 24, 2008 (AU) 2008906068

(51) Int. Cl. E04B 2/88; E04B 2/90; E04B 1/38; F16M 13/02

(52) U.S. Cl. 52/235; 248/205.1; 52/747.1; 52/745.21

(57) ABSTRACT

The present invention relates to a cladding system which includes a plurality of cladding means (26) interlocked with a plurality of the brackets (10). Each bracket (10) includes a support means (12) and means (22 & 24) for interlocking the brackets with the cladding means. The support means (12) is adapted to be fixed to a frame or an exterior of a building. The support means (12) is also adapted to support one or more cladding means (26). The interlocking means (22 & 24) is connected to or forming an integral part of the support means (12). The cladding means (26), when interlocked with the bracket (10), are capable of providing cladding without use of a substrate.

### TECHNICAL FIELD

This invention relates to a bracket suitable for use in cladding, particularly but not restricted to, at least part of a frame or an exterior of a house or building, and also to a cladding system including such a bracket.

### BACKGROUND OF THE INVENTION

Cladding is commonly provided to cover the exterior of a building in order to protect the structure from outside elements such as wind, rain and fire. Apart from for aesthetics purposes, cladding can be used for insulation against noise, termites and weather.

It is common practice to install the cladding on a substrate, such as metal, fibro, brick or cement sheeting, or weatherboard type products provided on the frame or exterior of the house or building. This practice however requires installation of the substrate as well as alignment of the substrate with the cladding to be installed, which unavoidably lead to high building costs.

It is therefore an object of the present invention to provide a bracket and a cladding system which may overcome or ameliorate the above shortcoming, or which will at least provide a useful alternative.

### DISCLOSURE OF THE INVENTION

According to one aspect of the present invention, there is provided a bracket including:
support means adapted to be fixed to a frame or an exterior of a building, and to support one or more cladding means; and
means for interlocking the bracket with each or the cladding means, the means being connected to or forming an integral part of the support means;

wherein the cladding means, when interlocked with the bracket, are capable of providing cladding without use of a substrate.

In a second aspect, the invention provides a cladding system including a plurality of cladding means interlocked with a plurality of the brackets of the invention.

Preferably, the cladding system includes one or more X-shaped sections, each of which has two intersecting blades being perpendicular to one another. More preferably, each blade is adapted to in use interlock with at least part of the cladding means.

In the cladding system of the present invention, a series of cladding means are provided and arranged in rows. It is preferred that the rows are staggered and interlocked with a series of brackets in between. Preferably, an adhesive material is applied on each peripheral surface of the cladding means so as to facilitate bonding thereof to an adjacent cladding means.

In a third aspect, the invention provides a method of cladding a frame or an exterior of a building, the method including the steps of:

(a) affixing a first bracket of the invention to the frame or exterior of the building;

(b) engaging one peripheral surface of a cladding means with an interlocking means which forms an integral part of or is connected to the bracket;

(c) engaging a second bracket of the invention with an opposing peripheral surface of the cladding means; and

(d) affixing the second bracket to the frame or exterior of the building.

The method may include the further step of providing an X-shaped section adapted to in use interlock with a lateral surface of the cladding means. The method may include the further step of engaging a lateral surface of an adjacent cladding means with the X-shaped section.

The method may include the yet further step of applying an adhesive material on the one or more lateral surfaces so as to enable the cladding means to adhere to or bond with one another thereby rendering the cladding impervious to rain.

In the present embodiment, the bracket includes an aluminium extrusion. The bracket however may be fabricated in different engineering materials and by other methods of moulding, for example.

Preferably, the support means includes a generally T-shaped body having vertical and horizontal members. More preferably, the horizontal member forms a base adapted to support the cladding means. Even more preferably, the vertical member is adapted to be in use fixed to the frame or exterior of a building via fasteners such as screws.

The cladding means may include veneers laminated to high density insulating foam. The veneers may be fibreboard, stone or artificial veneers. The cladding means may take any suitable form. It is preferred that the cladding means are arranged in rows. Preferably, the cladding means located in the middle of the rows are rectangular blocks whereas those positioned at corners of the building are L-shaped. The cladding means may include four peripheral faces, each of which includes a groove. It is preferred that the grooves are aligned such that they join up to form a continuous rebate.

It is preferred that the interlocking means includes an elongate tongue stemming from the horizontal member of the T-shaped body. In the most preferred embodiment, two interlocking means are provided extending in opposite directions from the horizontal member of the T-shaped body. The elongate tongue is preferred to be adapted to mate with one of the grooves of the rebate.

Conveniently, the peripheral faces of the cladding means are adhered to one another, for example, by an adhesive such as glue.

Typically, the frame or exterior of the building includes timber or metallic studs.

### BRIEF DESCRIPTION OF THE DRAWINGS

The invention may be better understood from the following non-limiting description of preferred embodiments, in which:

FIG. 1 is a perspective view of part of a bracket in accordance with one embodiment of the present invention;

FIG. 2 is a perspective view of part of a cladding system formed by a plurality of brackets of FIG. 1; and

FIG. 3 is a perspective view of the cladding system of FIG. 2 illustrating a cladding means adapted for corners.

### DETAILED DESCRIPTION OF THE DRAWINGS

In a general sense, the present invention is for cladding a frame or an exterior of a house or building.

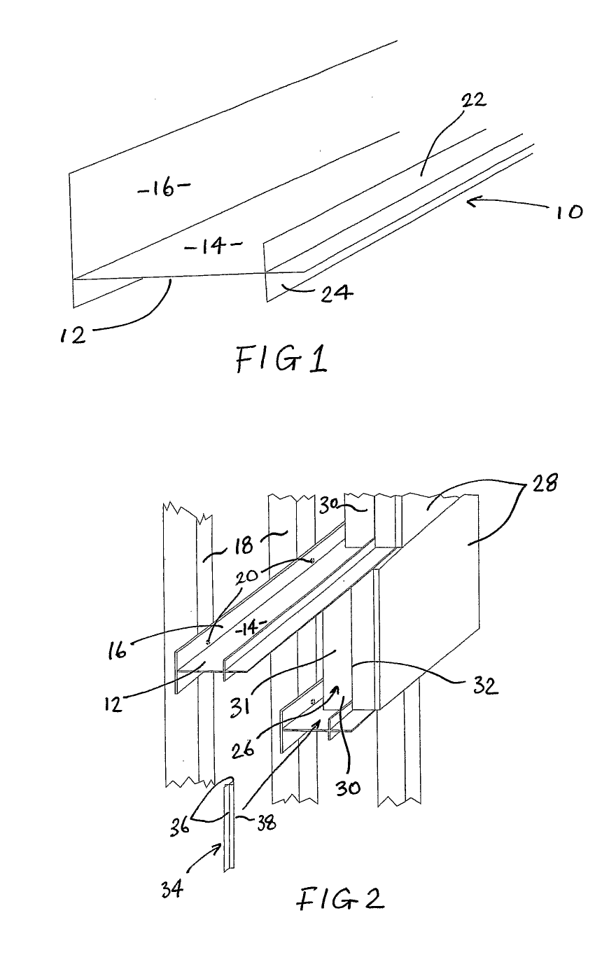

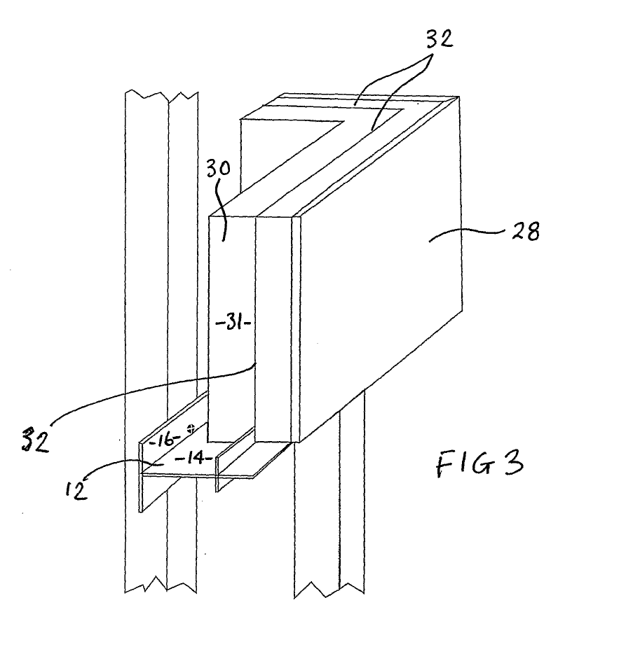

Referring to FIG. 1, a bracket 10 includes support means in the form of a T-shaped body 12 having a horizontal member 14 and a vertical member 16. The horizontal member 14 forms a base for supporting cladding means 26 (refer FIG. 2). As shown in FIG. 2, the vertical member 16 is fixed to studs 18 of the frame of a house via screws 20.

The bracket 10 also includes interlocking means in the form of elongate tongues 22 and 24. The elongate tongues 22 and 24 stem from the horizontal member 16 of the T-shaped body 12 and extend in opposition directions. The elongate tongues 22 and 24 in the present embodiment form an integral part of the T-shaped body 12.

Each cladding means 26 includes a veneer 28 laminated to high density insulating foam 30. The veneers 28 in the present embodiment are made of one of the following: fibreboard, stone and artificial material.

The cladding means 26 includes four peripheral faces, each having a groove 32. The grooves 32 are aligned such that they join up to form a continuous rebate (refer FIG. 3). When the cladding means 26 is placed on the T-shaped body 12, the elongate tongue 22 mates with the groove 32 of the rebate. As such, adjacent cladding means 26 are lined up neatly with the veneers 28 which are flush with one another. The peripheral faces 31 are adhered to one another by glue.

As shown in FIG. 2, the cladding means 26 can be installed and arranged in rows and columns. The cladding means 26 located in the middle of the rows are rectangular blocks, as in FIG. 2, whereas those positioned at corners of the house (or building) are L-shaped, as in FIG. 3.

It shall be appreciated that a plurality of brackets 10 of the present invention are used to form a cladding system in which the brackets 10 interlock with the cladding means 26. This arrangement of the cladding means 26 and brackets 10 results in the provision of cladding outside the frame of the house without requiring a substrate, which significantly reduces the building cost.

Turning to FIG. 2, the cladding system also includes a plurality of X-shaped sections 34, Each section 34 has two intersecting blades 36 and 38 being perpendicular to one another. In use, the blade 36 engages the lateral (vertical) groove 32 on the surface 31 of the cladding means 26. It will be appreciated that in the course of installing a series of cladding means 26, a section 34 is provided between each pair of adjacent cladding means 26 with the blade 38 abutting the peripheral surfaces 31. Glue is applied on each peripheral surface 31 of the cladding means 26 so as to facilitate bonding of adjacent cladding means 26 thereby enhancing the integrity of the cladding system. In a similar way, a plurality of brackets 10 of the present invention are provided in between adjacent rows of cladding means 26 which are staggered to form the cladding system.

Generally, sections 34 are used on lateral (vertical) grooves 32 whereas tongues 22 and 24 are slotted into horizontal grooves 32.

Application of the brackets 10 of the present invention to clad a frame (or an exterior of a building) will now be described. The first step is to affix a bracket 10 to the studs 18 of the frame. A cladding means 26 is then placed on the T-shaped body 12 of the bracket 10. The cladding means 26 is positioned on the T-shaped body 12 so that the elongate tongue 22 mates with the corresponding groove 32 on the bottom surface, (invisible in FIGS. 2 and 3) of the cladding means 26. A layer of glue is applied on the lateral peripheral surface of the cladding means 26 for bonding the surface 31 with another surface of the adjacent-cladding means. As such, the resulting cladding formed by the cladding means 26 is impervious to rain. The X-shaped section 34 is applied sideways, causing the blade 36 to mate with a corresponding groove 32 in the lateral (vertical) surface 31.

The same steps described above are repeated until a row of cladding means 26 is installed. Another bracket 10 of the present invention is then placed on top of the row of cladding means 26, so that a lower elongate tongue 24 mates with the rebate formed in the upper peripheral surface of the already installed cladding means 26. The new bracket is affixed onto the same studs 18 with screws 20.

It should be noted that the brackets 10 in this embodiment are made by extrusion using aluminium. Also, the studs 18 of the frame are made of timber or metal.

Those skilled in the art will appreciate that the invention described herein is susceptible to variations and modifications other than those specifically described. All such variations and modifications are to be considered within the scope and spirit of the present invention the nature of which is to be determined from the foregoing description.

### INDUSTRIAL APPLICABILITY

The present invention is industrially applicable in that it is capable of providing cladding without use of a substrate.

1. A bracket including:
support means adapted to be fixed to a frame or an exterior of a building, and to support one or more cladding means; and
means for interlocking the bracket with each of the cladding means, the means being connected to or forming an integral part of the support means;
wherein the cladding means, when interlocked with the bracket, are capable of providing cladding without use of a substrate.

2. A cladding system including a plurality of cladding means interlocked with a plurality of the brackets of claim 1.

3. The cladding system of claim 2, which includes one or more X-shaped sections, each of which has two intersecting blades being perpendicular to one another.

4. The cladding system of claim 3, wherein each blade is adapted to in use interlock with at least part of the cladding means.

5. The cladding system of claim 2, wherein the cladding means are arranged in rows.

6. The cladding system of claim 5, wherein the rows of cladding means are staggered and interlocked with the brackets lined up in series therebetween.

7. The cladding system of claim 2, wherein an adhesive material is applied on each peripheral surface of each cladding means so as to facilitate bonding thereof to an adjacent cladding means.

8. A method of cladding a frame or an exterior of a building, the method including the steps of:
(a) affixing a first bracket of the invention to the frame or exterior of the building;
(b) engaging one peripheral surface of a cladding means with an interlocking means which forms an integral part of or is connected to the bracket;
(c) engaging a second bracket of the invention with an opposing peripheral surface of the cladding means; and
(d) affixing the second bracket to the frame or exterior of the building.

9. The method of claim 8, which includes the further step of providing an X-shaped section adapted to in use interlock with a lateral surface of the cladding means.

10. The method of claim 9, which includes the further step of engaging a lateral surface of an adjacent cladding means with the X-shaped section.

11. The method of claim 10, which includes the yet further step of applying an adhesive material on the one or more lateral surfaces so as to enable the cladding means to adhere to or bond with one another.

12. The method of claim 8, wherein each bracket includes an aluminium extrusion.

13. The method of claim 8, wherein each bracket includes a support means in the form of a T-shaped body having vertical and horizontal members.

14. The method of claim 13, wherein the horizontal member forms a base adapted to support the cladding means.

15. The method of claim 13, wherein the vertical member is adapted to be in use fixed to the frame or exterior of a building.

16. The method of claim 8, wherein the cladding means includes veneers laminated to high density insulating foam.

17. The method of claim 16, wherein the veneers include fibreboard, stone or artificial veneers.

18. The method of claim 8, which includes the step of arranging the cladding means in rows.

19. The method of claim 18, wherein the cladding means located in the middle of the rows are rectangular blocks whereas those positioned at corners of the building are L-shaped.

20. The method of claim 8, wherein the or each cladding means includes four peripheral faces, each of which includes a groove.

21. The method of claim 20, wherein the grooves are aligned such that they join up to form a continuous rebate.

22. The method of claim 8, wherein the interlocking means includes an elongate tongue stemming from the horizontal member of the T-shaped body.

23. The method of claim 13, which includes the step of providing two interlocking means extending in opposite directions from the horizontal member of the T-shaped body.

24. The method of claim 22, which includes the step of mating the elongate tongue with one of the grooves of the rebate.

25. The method of claim 20, wherein the peripheral faces of the cladding means are adhered to one another by an adhesive.

26. The method of claim 8, which includes the step of including timber or metallic studs on the frame or exterior of the building.

27 to 29. (canceled)
